(19) United States
(12) Patent Application Publication
(10) Pub. No.: US 2023/0301470 A1
(43) Pub. Date: Sep. 28, 2023

(54) CHEMICAL TOILET CABIN

(71) Applicant: Alessio DAINELLI, San Gimignano (IT)

(72) Inventor: Alessio DAINELLI, San Gimignano (IT)

(21) Appl. No.: 18/189,363

(22) Filed: Mar. 24, 2023

(30) Foreign Application Priority Data
Mar. 24, 2022 (IT) 102022000005903

(51) Int. Cl. A47K 11/02; F16B 2/20

(52) U.S. Cl. CPC A47K 11/02; F16B 2/20

(57) ABSTRACT

A chemical toilet cabin includes a platform, vertical side walls, a frame with a door and a roof; reversible joint connection provided along the edges of the vertical walls and of the frame and on the opposing faces of the platform and of the roof to removably join the walls, the frame, the platform and the roof, reversible locking mechanism of the joint connections being provided between the walls, the frame and the platform and the roof; in which each of the vertical side walls is made of two panels configured in such a way as to be joined one another along two corresponding sides by a snap connection.

### FIELD

The present invention relates to an improved chemical toilet cabin. More particularly, the invention relates to a knock-down cabin for a chemical toilet with composite walls.

### BACKGROUND

As is known, a portable toilet is a sanitary appliance which uses a chemical agent for bowl sanitizing after each use. It finds application in all those circumstances where a sewage system is not available for the discharge of bodily wastes which instead are collected in a reservoir with which the toilet is equipped. The chemical toilet is therefore widely used on trains, planes, campers, caravans, and the like. Another widespread use of the chemical toilet is on construction sites, in events, shows and outdoor entertainments and the like, and in this case the chemical toilet consists of a cabin which is portable and arranged for temporary installations, in which the bowl and the waste material collection reservoir, the reservoir for the sanitizing chemical agents, and possibly a hand basin, a urinal, a clean water reservoir and any other accessory device necessary for its use and/or dictated by local regulations and/or use standards.

WO2017149454A1 (EP3422918B1) describes a knock-down chemical toilet cabin, which cabin comprises a platform, vertical side walls connected to the platform, and a roof connected to the walls, and reversible locking connection means provided in it formed along the edges of the walls and on the opposite faces of the platform and the roof to removably join each wall to the walls adjacent thereto, to the platform and to the roof. Means are also provided for reversible locking of this interlocking connection arranged between a wall and the adjacent wall and between each of said walls and said platform and said roof.

In the cabin described above, each of the side walls consists of a single panel and is made, like the platform and the roof, in polyethylene by rotational molding.

The cabin object of the application WO2017149454A1 effectively achieves the set purposes, but is susceptible of considerable improvements as regards the side walls, both in constructive and structural terms.

In fact, the realization of the panel forming the wall in a single piece by rotational molding entails difficulties in finding systems able to create panels of the required dimensions (typically 200 cm X 110 cm) as well as particularly long molding times (of the order of 2 hours) which heavily affect the overall manufacturing costs of the cabin.

Furthermore, the wall made in a single piece by rotational molding can be fragile in the central area, in the absence of transversal reinforcements.

### SUMMARY

The object of the present invention is therefore to provide a knock-down chemical toilet cabin which obviates the drawbacks highlighted above. Said object is achieved with a knock-down chemical toilet cabin according to the present invention whose essential features are set forth in claim 1. Further important features are set forth in the dependent claims.

The advantages of the invention will be better understood, together with the features of the cabin, from the following description and from the annexed drawings, given as a non-limiting example of embodiment.

### BRIEF DESCRIPTION OF THE DRAWINGS

FIG. 1 is a top perspective view of an improved knock-down chemical toilet cabin according to the invention;

FIG. 2 is a partial top plan view of the cabin of FIG. 1;

FIG. 3 is a partial perspective view of the interior of the cabin;

FIG. 4 is an external front view of a wall of the cabin;

FIG. 5 is an internal front view of a wall of the cabin;

FIG. 6 is a partial exploded external view of the wall.

FIG. 7 is a partial exploded internal view of the wall.

### DETAILED DESCRIPTION

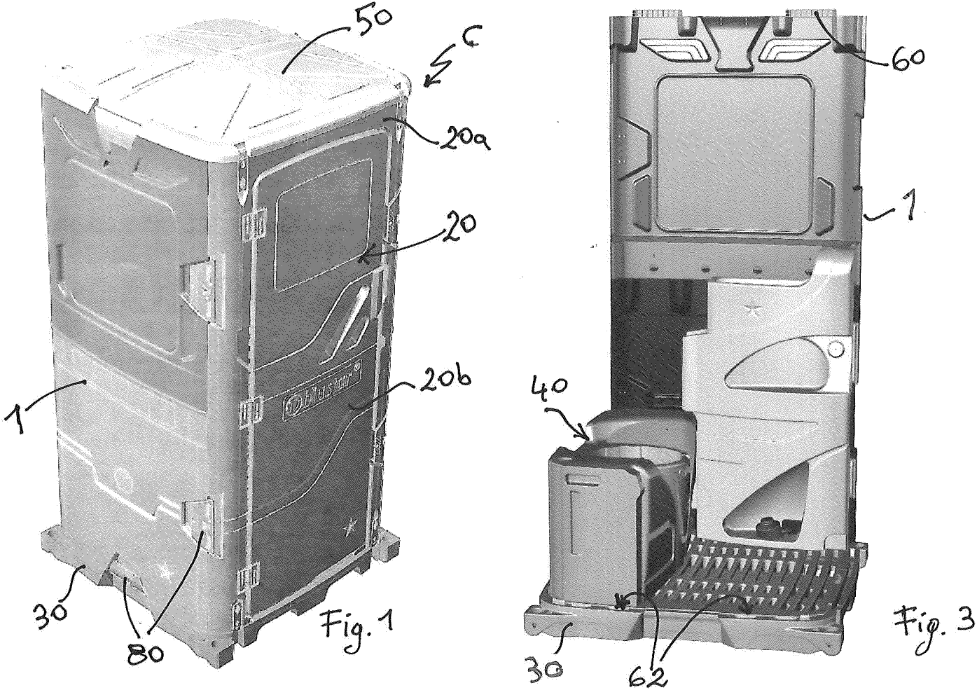

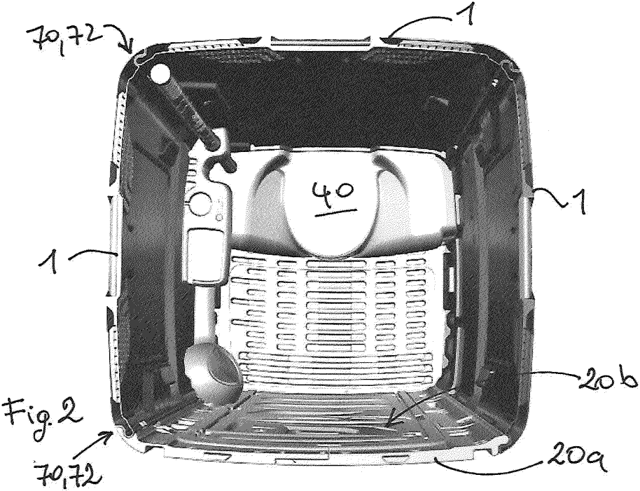

With reference to FIGS. 1 to 3, it has generally indicated at C a chemical toilet cabin according to the invention. Cabin C comprises three consecutive equal vertical walls 1 arranged at 90° to each other and a fourth wall 20 substantially formed by a frame 20a, within which a cabin access door 20b is mounted, fixed to two respective sides of the two opposite walls. The three vertical walls 1 and the frame 20a rise from a substantially square platform 30 on which a seat is made which is intended to house the bottom portion of a bodily wastes collection tank with relative opening and toilet seat, indicated as a whole by 40. Above a roof 50 is arranged (removed in FIG. 2) which is fixed to the upper edges of the three vertical walls 1 and of the frame 20a.

The platform 30 and the roof 50 are connected to the vertical walls 1 and to the frame 20a by means of reversible interlocking connections. In particular, said interlocking connections are of the male-female type and are formed by appendices 60 extending along the lower and upper edges of the walls 1 and of the frame 20a and destined to engage in corresponding seats 62 formed peripherally on the internal faces, i.e. facing towards each other, of the platform 30 and of the roof 50.

Likewise the walls are mutually connected by means of ribs 70 and corresponding grooves 72 provided along the side edges of each wall.

To make the interlocking connection between the elements making up the cabin C stable, the walls are blocked two by two and to the frame, in correspondence with two respective adjacent vertical sides, and, respectively, to the platform 30 and to the roof 50, by means of locking of the interlocking connections consisting of lever closures 80 of the type illustrated in application WO2017149454A1.

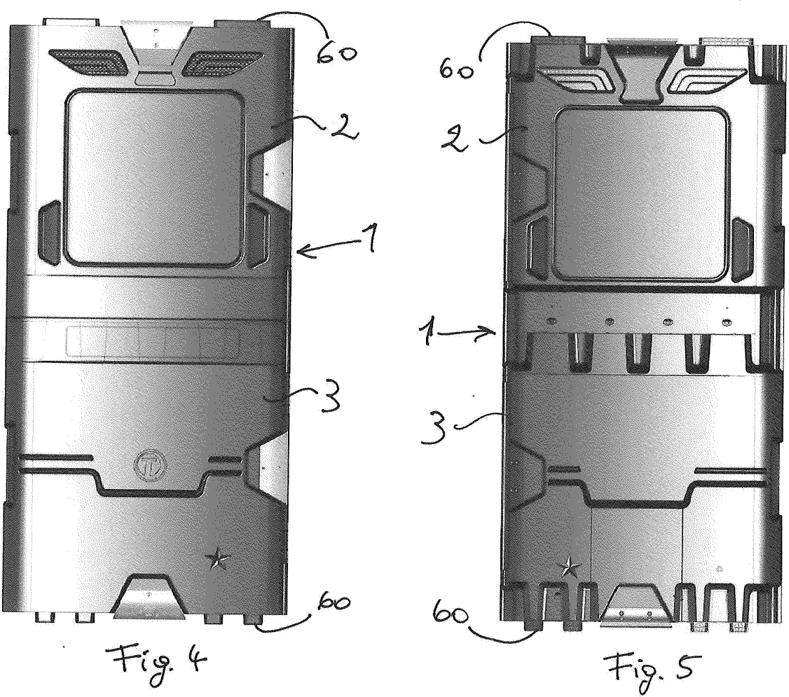

In FIG. 4 the wall 1 is shown in its external view, i.e. facing outwards once it has been mounted with the other walls and other components of the cabin, whereas in FIG. 5 the wall is shown in its internal view, i.e. the one facing towards the inside of the chemical toilet.

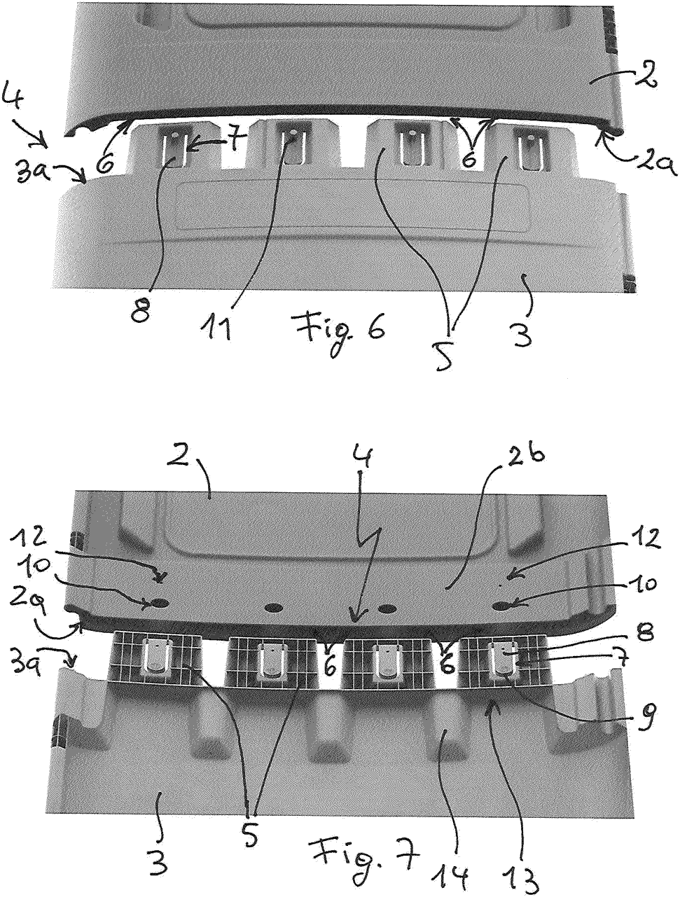

According to the invention, the wall 1 is formed by two panels 2, 3 advantageously made by injection molding in plastic material, for example polyethylene. The two panels 2, 3 are configured so that they can be joined together along two corresponding sides 2a, 3a. In a preferred embodiment, the union between the two panels 2, 3 is ensured by snap connection means illustrated in FIGS. 6 and 7. Said snap connection means are generally indicated with 4 and comprise teeth 5 extending from the side 3a of the first panel 3 and engagement seats 6 for the teeth 5 obtained along the side 2a of the second panel 2.

Each tooth 5 internally delimits a window 7 within which a tab 8 extends connected to the side of the window adjacent to the free end of the tooth. On one face of the tab 8, near its free end, there is a button 9 projecting orthogonally from it forming the male element of the snap connection, the female element being constituted by a through hole 10 correspondingly formed on the inner face of the second panel 2 delimiting the engagement seat 6.

The snap connection between the panels 2, 3 is achieved by making the teeth 5 slide into the corresponding engagement seats 6, overcoming the resistance of the tabs 8 which yield flexibly during sliding until the buttons 9 arrive at the through holes 10 and engage within them, blocking any further relative sliding of the two panels.

If it is necessary to separate the two panels 2, 3 for example for maintenance operations or replacement of a damaged panel, the buttons 9 must be pushed inwards at the same time so as to disengage them from the corresponding through holes 10, thus allowing the sliding of the teeth 5 in their engagement seats 6 until the complete separation of the two panels. If the connection between the two panels 2, 3 should be reinforced, it is possible to lock it with screws. For this purpose, a cylinder 11 extends from the opposite face of each tab 8 with respect to the one from which the button 9 protrudes which, once the snap connection has been made, being aligned with a hole 12 formed in the second panel 2 at a suitable distance above the through hole 10. Said hole 12 acts as a reference for screwing a screw, not shown, to the underlying cylinder 11.

In the illustrated embodiment, the teeth 5 extend from a shelf 13 projecting internally from the side 3a of the panel 3 and supported by support elements 14 integral therewith and with the internal face of the panel 3. In turn, the engagement seats 6 are obtained in a gap delimited by the internal face of the panel 2 and by a counterwall 2b facing said gap.

In the illustrated embodiment, panel 2 constitutes the upper part of the wall 1 and panel 3 the lower part, the terms “upper” and “lower” referring to the vertical position that the wall assumes once it has been assembled to form the chemical toilet cabin. In a completely equivalent way, the teeth 5 and the respective engagement seats 6 can be provided on the panel 2 and, respectively, on the panel 3, unlike what has been illustrated above.

The wall according to the present invention offers considerable advantages in terms of simplicity and speed of production, as well as transversal solidity, in the construction of a chemical toilet cabin substantially as illustrated in FIG. 1.

Although the wall according to the invention has been described here for making a chemical toilet cabin according to the European application EP3422918B1, it is clear that it can also be used to make chemical toilet cabins of different types whenever it is advisable to make one or multiple walls in two parts or when the need arises for transverse reinforcement of the walls.

1. A chemical toilet cabin comprising:
a platform, vertical side walls, a frame supporting a door and a roof,
a reversible joint connection formed along the edges of said vertical walls and said frame and on opposed faces of said platform and said roof to removably join the walls to each other, the frame, the platform and the roof, reversible lock of said joint
connection being arranged between the walls, the frame, the platform and the roof,
wherein each side vertical wall is formed by two panels configured to be connected to each other along two corresponding sides by a snap-on connection.

2. The cabin according to claim 1, wherein said snap-on connection comprise teeth extending from one side of a first one of the two panels and engagement seats for said teeth formed along a side of the second panel.

3. The cabin according to claim 2, wherein a window is formed in each tooth and a tab connected to the side of the window adjacent to the free end of the tooth extends in said window, on one face of the tab, near its free end, a button being provided projecting orthogonally from said face and forming the male element of the snap-on connection, the female element being constituted by a through hole correspondingly formed on the inner face of the second panel delimiting the engagement seat.

4. The cabin according to claim 3, wherein a cylinder extends from the face of each tab opposite to the face from which the button protrudes, said cylinder, once the snap connection has been made, being aligned to a hole formed in the second panel at a suitable distance above the through hole, said hole acting as a reference for screwing a screw to the underlying cylinder.

5. The cabin according to claim 2, wherein the teeth extend from a shelf projecting internally from the side of the panel and supported by support elements integral therewith and with the internal face of the panel.

6. The cabin according to claim 2, wherein the engagement seats are formed in a gap delimited by the internal face of the panel and by a counterwall facing said gap.

7. The cabin according to claim 2, wherein the panels are made by injection moulding of plastic material, preferably polyethylene.
